(19) United States
(12) Patent Application Publication
(10) Pub. No.: US 2007/0000883 A1
(43) Pub. Date: Jan. 4, 2007

(54) Laser welding apparatus and system

(76) Inventor: Chang Ho Jung, Ulsan-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/305,724

(22) Filed: Dec. 15, 2005

(30) Foreign Application Priority Data
Jun. 30, 2005 (KR) 10-2005-0057797

(51) Int. Cl. B23K 26/24

(52) U.S. Cl. 219/121.63; 219/121.78

(57) ABSTRACT

Since a welding apparatus according to an exemplary embodiment of the present invention is formed to radiate a laser beam at at least one position in at least one direction, a working hour may be reduced and productivity may be increased when a welding operation is performed by using the welding apparatus according to the exemplary embodiment of the present invention.

### CROSS-REFERENCE TO RELATED APPLICATION

This application claims priority to and the benefit of Korean Patent Application No. 10-2005-0057797 filed in the Korean Intellectual Property Office on Jun. 30, 2005, the entire contents of which are incorporated herein by reference.

### BACKGROUND OF THE INVENTION

(a) Field of the Invention

The present invention relates to a laser welding apparatus, and more particularly, to a welding apparatus and a system for performing a plurality of welding operations at at least one position.

(b) Description of the Related Art

A laser welding apparatus includes a welding head for radiating a laser beam, and the welding head is attached to a multi-joint robot arm. The robot arm is typically moved to radiate the laser beam to a plurality of welding points.

However, there have been problems in that the conventional robot arms are so heavy to be quickly moved, and it is required to move the robot arm whenever a welding operation is performed. Therefore, when the conventional laser welding apparatus is used, a working hour may be increased, and productivity may be reduced.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide a laser welding apparatus and system for reducing a working hour by performing a plurality of welding operations at one move of a robot arm.

An exemplary welding apparatus according to an embodiment of the present invention includes a laser oscillator, a laser welding head, and a robot arm. The laser oscillator generates a laser beam. The laser welding head receives the laser beam generated by the laser oscillator, and is formed to radiate the received laser beam at at least one position in at least one direction. The robot arm supports the welding head so as to move the welding head. The exemplary welding apparatus further includes a cable coupling the laser oscillator and the laser welding head to supply the laser beam generated by the laser oscillator to the laser welding head.

The laser welding head includes a laser beam receiving unit receiving the laser beam from the laser oscillator, a reflecting mirror unit receiving the laser beam from the laser beam receiving unit and radiating the received laser beam to a welding workpiece, a driving unit driving the reflecting mirror unit to switch a direction of the radiated laser beam, and a power supply device supplying a power source to the driving unit.

The laser beam receiving unit includes a regulator receiving the laser beam from the cable and adjusting the laser beam to regulate a propagation direction of the laser beam to a first direction.

The reflecting mirror unit includes a first reflecting mirror for reflecting the laser beam so as to regulate the propagation direction of the laser beam to a second direction, and a second reflecting mirror for reflecting the laser beam so as to regulate the propagation direction of the laser beam to a third direction.

The driving unit includes a first driver driving the regulator, a second driver driving the first reflecting mirror, and a third driver driving the second reflecting mirror.

An exemplary welding system according to an embodiment of the present invention includes a laser oscillator, a laser welding head, a robot arm, and a utility supply unit. The laser oscillator generates a laser beam. The laser welding head receives the laser beam generated by the laser oscillator, and is formed to radiate the received laser beam at at least one position in at least one direction. The robot arm supports the welding head to move the welding head. The utility supply unit supplies a coolant to the welding head and the laser oscillator. The exemplary welding system further includes a cable coupling the laser oscillator and the welding head to supply the laser beam generated by the laser oscillator to the welding head.

The welding head includes a laser beam receiving unit receiving the laser beam from the laser oscillator, a reflecting mirror unit receiving the laser beam from the laser beam receiving unit and radiating the received laser beam to a welding workpiece, a driving unit driving the reflecting mirror unit to switch a direction of the radiated laser beam, and a power supply device supplying a power source to the driving unit.

The laser beam receiving unit includes a regulator receiving the laser beam from the cable and adjusting the laser beam to regulate a propagation direction of the laser beam to a first direction.

The reflecting mirror unit includes a first reflecting mirror for reflecting the laser beam so as to regulate the propagation direction of the laser beam to a second direction, and a second reflecting mirror for reflecting the laser beam so as to regulate the propagation direction of the laser beam to a third direction.

The driving unit includes a first driver driving the regulator, a second driver driving the first reflecting mirror, and a third driver driving the second reflecting mirror.

### BRIEF DESCRIPTION OF THE DRAWINGS

FIG. 1 shows a diagram representing a laser welding apparatus according to an exemplary embodiment of the present invention.

FIG. 2 shows a diagram representing a welding head according to the exemplary embodiment of the present invention.

FIG. 3 shows a diagram representing an operation of the welding apparatus according to the exemplary embodiment of the present invention.

FIG. 4 shows a schematic diagram representing a welding system according to the exemplary embodiment of the present invention.

### DETAILED DESCRIPTION OF THE EMBODIMENTS

An exemplary embodiment of the present invention will hereinafter be described in detail with reference to the accompanying drawings.

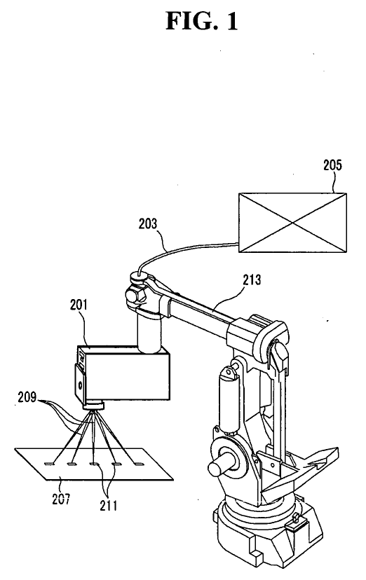

As shown in FIG. 1, the welding apparatus according to the exemplary embodiment of the present invention includes a laser oscillator 205, a welding head 201, and a robot arm 213.

The laser oscillator 205 generates a laser beam 209.

The welding head 201 receives the laser beam 209 generated by the laser oscillator 205, and is formed such that the received laser beam 209 may be radiated to at least one position in at least one direction.

The robot arm 213 supports the welding head 201 so as to move the welding head 201.

The cable 203 couples the laser oscillator 205 to the welding head 201 so as to supply the laser beam 209 generated by the laser oscillator 205 to the welding head 201.

The laser beam 209 generated by the laser oscillator 205 is transmitted to the welding head 201 through the cable 203, and the transmitted laser beam 209 is radiated from the welding head 201 to a plurality of predetermined welding points 211 of the welding workpiece 207.

The robot arm 213 moves the welding head 201 to a plurality of predetermined positions, and the welding head 201 may radiate the laser beam 209 to the plurality of predetermined welding points 211 at the plurality of predetermined positions positioned by the robot arm 213.

That is, according to the exemplary embodiment of the present invention, when the welding head 201 is positioned at one position, the laser beam 209 may be radiated to the plurality of predetermined welding points 211.

In addition, when the welding head 201 is moved, the laser beam 209 may be radiated to a plurality of welding points 211 that are established at another position.

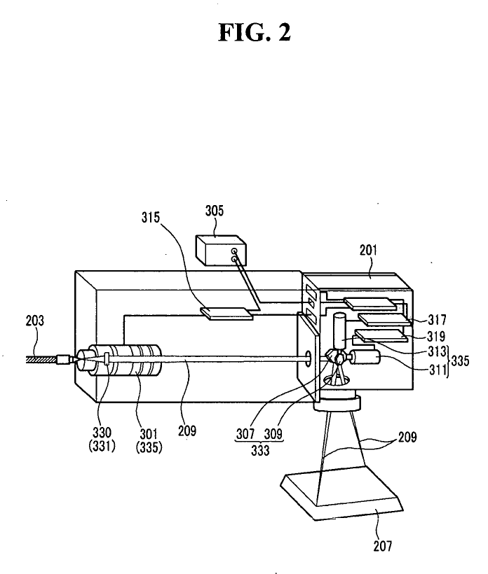

FIG. 2 shows a diagram representing the welding head according to the exemplary embodiment of the present invention. The welding head 201 includes a laser beam receiving unit 331, a reflecting mirror unit 333, a driving unit 335, and a power supply device 305.

The laser beam receiving unit 331 receives the laser beam 209 from the laser oscillator 205.

The reflecting mirror unit 333 receives the laser beam 209 from the laser beam receiving unit 331 and radiates the received laser beam 209 to the welding workpiece 207.

The driving unit 335 drives the reflecting mirror unit 333 so as to switching a direction for radiating the laser beam 209, and the power supply device 305 supplies a power source to the driving unit 335.

The laser beam receiving unit 331 includes a regulator 330 receiving the laser beam 209 from the cable 203 and controlling the laser beam 209 so as to regulate a propagation direction of the laser beam 209 to a first direction.

The laser beam 209 generated by the laser oscillator 205 is transmitted to the laser beam receiving unit 331 of the welding head 201 through cable 203.

The transmitted laser beam 209 is transmitted to the regulator 330 of the laser beam receiving unit 331, and is transmitted in the first direction by the regulator 330.

In the exemplary embodiment of the present invention, the regulator 330 may regulate a focus of the laser beam 209 from the regulator 330 to the welding workpiece 207.

The direction will be described later in detail.

The laser beam 209 regulated in the first direction by the regulator 330 is transmitted to the reflecting mirror unit 333, and is radiated to the welding workpiece 207 since it is reflected by the reflecting mirror unit 333.

The reflecting mirror unit 333 includes a first reflecting mirror 307 and a second reflecting mirror 309.

The first reflecting mirror 307 reflects the laser beam 209 to regulate the propagation direction of the laser beam 209 to a second direction, and reflects the laser beam 209 to regulate the propagation direction of the laser beam 209 to a third direction.

That is, the laser beam 209 regulated in the first direction by the regulator 330 is reflected in the second direction by the first reflecting mirror 307, and then, is reflected in the third direction by the second reflecting mirror 309.

The first, second, and third directions are formed perpendicular to each other. That is, the three directions may form a three dimensional rectangular coordinates.

The third direction is realized toward one point among the plurality of welding points 211 of the welding workpiece 207.

That is, the laser beam 209 reflected in the third direction is radiated to the welding point 211 of the welding workpiece 207 so as to perform a welding operation.

The driving unit 335 includes a first driver 301, a second driver 311, and a third driver 313.

The first driver 301 drives the regulator 330, the second driver 311 drives the first reflecting mirror 307, and the third driver 313 drives the second reflecting mirror 309.

Therefore, the first direction is regulated in the regulator 330 by the first driver 301, the second direction is regulated in the second driver 311 by the first reflecting mirror 307, and the third direction is regulated in the third driver 313 by the second reflecting mirror 309.

The first, second, and third drivers 301, 311, and 313 are controlled by control units 315, 319, and 317.

According to the exemplary embodiment of the present invention, the welding head 201 may perform the welding operation at least one position in various patterns by the control units 315, 319, and 317, and the three drivers 301, 311, and 313.

The control units 315, 319, and 317 may be respectively realized by at least one microprocessor operating by a predetermined program, and the predetermined program may vary according to the number of the plurality of predetermined welding points 211 of the welding workpiece 207 and a welding order thereof by those skilled in the art.

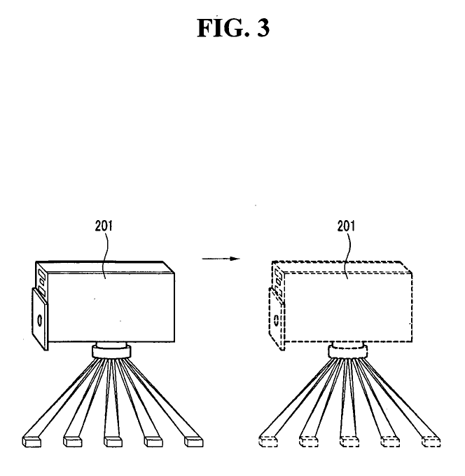

Referring to FIG. 3, the welding head 201 is moved by the robot arm 213 (see an arrow shown in FIG. 3), and the laser beam 209 is radiated to the plurality of welding points 211 at respective positions.

That is, when the robot arm 213 moves the welding head 201, the welding head 201 welds a predetermined number of the welding points.

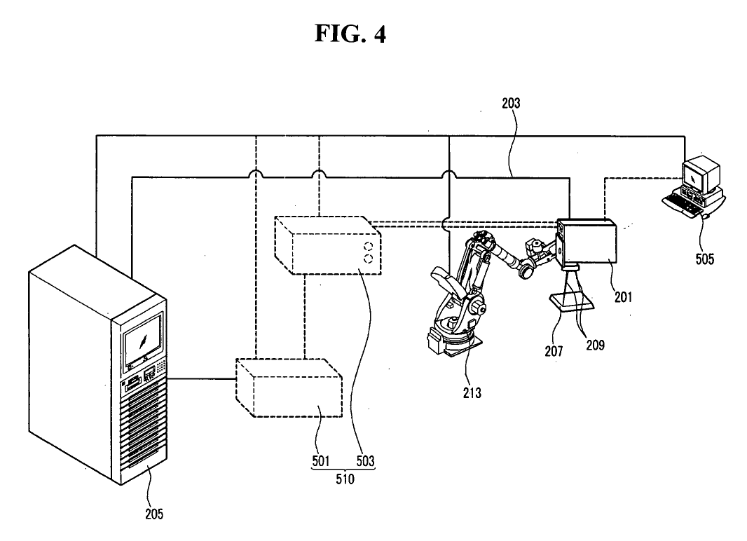

FIG. 4 shows a schematic diagram representing a welding system according to the exemplary embodiment of the present invention.

The welding system according to the exemplary embodiment of the present invention includes the welding apparatus and a utility supply unit 510.

The utility supply unit 510 provides a coolant to the welding head 201 and the laser oscillator 205 that produce heat, and includes a cooler 501 and a utility supply device 503.

In addition, the welding system according to the exemplary embodiment of the present invention may include an additional control portion 505, and the additional control portion 505 may control the welding apparatus and the utility supply unit 510.

According to the exemplary embodiment of the present invention, since the welding head performs a plurality of welding operations when the robot arm moves the welding head to a predetermined position, a working hour may be reduced, and productivity may be increased. In addition, the welding operation may be performed in various patterns since the welding head includes the driving unit.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scone of the appended claims.

What is claimed is:

1. A welding apparatus comprising:
a laser oscillator generating a laser beam;
a laser welding head receiving the laser beam generated by the laser oscillator, the laser welding head formed to radiate the received laser beam at at least one position in at least one direction; and
a robot arm supporting the welding head so as to move the welding head.

2. The welding apparatus of claim 1, further comprising
a cable coupling the laser oscillator and the laser welding head to supply the laser beam generated by the laser oscillator to the laser welding head.

3. The welding apparatus of claim 1, wherein the laser welding head comprises:
a laser beam receiving unit receiving the laser beam from the laser oscillator;
a reflecting mirror unit receiving the laser beam from the laser beam receiving unit and radiating the received laser beam to a welding workpiece;
a driving unit driving the reflecting mirror unit to switch a direction of the radiated laser beam; and
a power supply device supplying a power source to the driving unit.

4. The welding apparatus of claim 3, wherein the laser beam receiving unit comprises a regulator receiving the laser beam from the cable and adjusting the laser beam to regulate a propagation direction of the laser beam to a first direction.

5. The welding apparatus of claim 4, wherein the reflecting mirror unit comprises:
a first reflecting mirror for reflecting the laser beam so as to regulate the propagation direction of the laser beam to a second direction; and
a second reflecting mirror for reflecting the laser beam so as to regulate the propagation direction of the laser beam to a third direction.

6. The welding apparatus of claim 5, wherein the driving unit comprises:
a first driver driving the regulator;
a second driver driving the first reflecting mirror; and
a third driver driving the second reflecting mirror.

7. A welding system comprising:
a laser oscillator generating a laser beam;
a laser welding head receiving the laser beam generated by the laser oscillator, the laser welding head formed to radiate the received laser beam at at least one position in at least one direction;
a robot arm supporting the welding head to move the welding head; and
a utility supply unit supplying a coolant to the welding head and the laser oscillator.

8. The welding system of claim 7, further comprising
a cable coupling the laser oscillator and the welding head to supply the laser beam generated by the laser oscillator to the welding head.

9. The welding system of claim 7, wherein the welding head comprises:
a laser beam receiving unit receiving the laser beam from the laser oscillator;
a reflecting mirror unit receiving the laser beam from the laser beam receiving unit and radiating the received laser beam to a welding workpiece;
a driving unit driving the reflecting mirror unit to switch a direction of the radiated laser beam; and
a power supply device supplying a power source to the driving unit.

10. The welding system of claim 3, wherein the laser beam receiving unit comprises a regulator receiving the laser beam from the cable and adjusting the laser beam to regulate a propagation direction of the laser beam to a first direction.

11. The welding system of claim 10, wherein the reflecting mirror unit comprises:
a first reflecting mirror for reflecting the laser beam so as to regulate the propagation direction of the laser beam to a second direction; and
a second reflecting mirror for reflecting the laser beam so as to regulate the propagation direction of the laser beam to a third direction.

12. The welding system of claim 11, wherein the driving unit comprises:
a first driver driving the regulator;
a second driver driving the first reflecting mirror; and
a third driver driving the second reflecting mirror.
